(19) United States
(12) Patent Application Publication
(10) Pub. No.: US 2013/0263394 A1
(43) Pub. Date: Oct. 10, 2013

(54) Pressure Washer/Surface Cleaner

(71) Applicants: Philip H. Larimore, Buckley, WA (US); Ronald G. Fenili, Enumclaw, WA (US)

(72) Inventors: Philip H. Larimore, Buckley, WA (US); Ronald G. Fenili, Enumclaw, WA (US)

(21) Appl. No.: 13/440,774

(22) Filed: Apr. 5, 2012

(51) Int. Cl. B05B 3/00; A46B 13/00

(52) U.S. Cl. 15/21.1; 239/146; 239/172

(57) ABSTRACT

The present invention provides an improved pressure washer/surface cleaner with three wheels, one of which swivels and has a locking mechanism, that is easy to maneuver over many types of surfaces with less vibration from the motor, with little dangerous, damaging over spray and with a removable handle.

### BACKGROUND OF THE INVENTION

1. Field of the Invention

The present invention relates generally to the field of devices for pressure washing horizontal surfaces with water and an optional cleaning agent.

2. Description of the Prior Art

High pressure washing machines exist that are designed specifically for cleaning flat surfaces. One type is a separate surface washer with wheels and connected to a pressure washer unit by a high pressure hose. Another type has the pressure washer and surface cleaner combined. These pressure washer/surface cleaners use a motor with a pressure pump attached thereto, mounted to a frame. The frame is supported by four wheels. Additionally, a round housing that contains a rotating union fitted with arms that rotate and have nozzles attached to the end of the arms, is suspended from the frame. The rotating union is connected by means of a high pressure hose to the pressure washer pump. The pressure washer/surface cleaner in turn has a valve attached to the handle of the pressure washer/surface cleaner to redirect the water to a wand connected to a high pressure hose. In surface cleaning mode, the pressure washer/surface cleaner is moved across the surface that is to be cleaned. The problem with this setup it that the pressure washer/surface cleaner is difficult to maneuver and correct the direction of the pressure washer/surface cleaner and the motor vibrates excessively. The over spray from these pressure washer/surface cleaners is excessive and dangerous.

One variant applied shields to the bottom of the round housing to prevent over spray. In either case the over spray dislodges debris that dangerous to the operator and persons in the vicinity of the machine. The configuration does not allow the user to clean surfaces close to horizontal or vertical objects.

When used as a standard pressure washer, the pressure washer/surface cleaners move in an uncontrolled manner, creating dangerous operational conditions, causing injury to others, causing various component parts of the pressure washer/surface cleaner to wear excessively, shortening the life of the parts and the pressure washer/surface cleaner as a whole. The pressure washer/surface cleaners are hard to transport. A need exists, therefore, for an improved pressure washer/surface cleaner.

### BRIEF SUMMARY OF THE INVENTION

The present invention provides a three wheel pressure washer/surface cleaner that is easy to maneuver over many types of surfaces with less vibration from the motor, with little dangerous, damaging over spray and with a removable handle, that is an improved pressure washer/surface cleaner. A motor and high pressure pump and chassis with two pneumatic wheels that are commercially available are used in construction of the present invention. The motors and high pressure pumps are available with a variety of power ratings. The invention consists of a substantially modified commercially available pressure washer/surface cleaner.

The three wheel pressure washer/surface cleaner comprising a chassis made up of a tubular frame and platform that has a motor attached to the platform. The motor has a high pressure pump attached to it. The pressure washer/surface cleaner uses a three wheel for suspension. Two pneumatic wheels are attached to the tubular frame either at the front of the tubular frame or at the rear of the tubular frame. The relationship of front to rear is determined by the location of the handle that is used to direct the pressure washer/surface cleaners movement. The rear location is located at the handle end of the pressure washer/surface cleaner and the front is located at the opposite end of the pressure washer/surface cleaner. The top of the handle may be removed for transportation of the pressure washer/surface cleaner. A metal arm of appropriate width and a length sufficient to allow a swivel wheel to rotate 360 degrees is attached to the top of the platform starting at the end of the base of the motor with a hole drilled into the metal arm to permit the attachment of the high pressure hose to a rotating union. The pressure washer/surface cleaner in this configuration is easy to maneuver. It can be used very close to vertical or horizontal objects without damaging and destroying the objects. The configuration is safer for the operator as well.

Elastometric vibration absorbers are attached to the motor mount base onto the motor's existing holes located on the base of the motor and attached to the platform. The platform is reinforced with metal attached to the under surface of the platform. Attached to the metal arm is another elasotmetric vibration absorber that allows the pressure washer pump to rest upon pump. The end of the metal arm is attached to a swivel wheel of appropriate size to support the weight of the pressure washer/surface cleaner. Between the metal arm and the swivel wheel is a further vibration absorber that is the width and length of the attaching base of the swivel wheel. When the pressure washer/surface washer is used in a stationary manner with a hose attached to a wand, the swivel wheel can be locked to prevent unintended dangerous movement of the machine.

Attached to the bottom side of the platform is a round metal or non-metallic housing that contains a rotating union with arms that have spray nozzles attached. A brush, that is the length of the circumference of the housing, is attached to bottom of the circumference of the housing. The brush is positioned on the base of the housing such that it allows for the movement of the brush along the surface without touching the surface, but close enough to the surface to prevent water and debris from being distributed in all directions. The brush is a safety device that prevents injury to operators of the pressure washer/surface cleaner and persons in the vicinity of it, since the brush prevents debris from being distributed at high velocity by the spinning arms and nozzles.

The pressure washer pump is attached by means of a high pressure hose to a three-way valve. The three-way valve in turn is attached either to a standard pressure washer wand with a long length of high pressure hose and/or with a short length of high pressure hose to the rotating arm. The three-way valve can be switched to allow the use of a standard pressure washer wand or the rotating union.

The objects of the invention include: providing an improved pressure washer/surface cleaner that is mounted on three wheels, is easy to maneuver, is safe to use and is easier to transport; that will not vibrate excessively thereby increasing safety to others and increasing the life of the pressure washer/surface cleaner; that has little over spray to destroy and damage people, horizontal and vertical objects when used in the surface cleaning configuration; and, that will remain at rest and not move randomly during operation in the pressure washing configuration with the wand. Other aspects of the invention will become apparent by consideration of the detailed description and accompanying drawings.

### BRIEF DESCRIPTION OF DRAWINGS

FIG. 1 is a isometric view of a pressure washer/surface cleaner with the swivel wheel in the front configuration according to the present invention.

FIG. 2 is a isometric view of a pressure washer/surface cleaner with the swivel wheel in rear configuration according to the present invention.

FIG. 3 is a side view of the pressure washer/surface cleaner with the swivel wheel in the front wheel configuration according to the present invention.

FIG. 4 is a side view of the pressure washer/surface cleaner with the swivel wheel in the rear wheel configuration according to the present invention.

FIG. 5 is a frontal view of the pressure washer/surface cleaner with swivel wheel in the front configuration according to the present invention illustrating the control valve.

FIG. 6 is a frontal view of the pressure washer/surface cleaner with swivel wheel in the rear configuration according to the present invention illustrating the control valve.

FIG. 7 is a side view of the elastometric vibration absorbers that are mounted to the motor, high pressure pump and metal arm that has the swivel wheel according to the front wheel configuration of the present invention.

FIG. 8 is a side view of the elastometric vibration absorbers that are mounted to the motor, high pressure pump and metal arm that has the swivel wheel according to the rear wheel configuration of the present invention.

### DETAILED DESCRIPTION OF ILLUSTRATED EMBODIMENTS

In the following description, for the purposes of explanation, numerous specific details are set forth in order to provide a thorough understanding of the three-wheel pressure washer/surface cleaner of the present invention. It will be apparent, however, to one skilled in the art that the three-wheel pressure washer/surface cleaner may be practiced without some of these specific details. Throughout this description, the embodiments and examples shown should be considered as exemplars, rather than as limitations on the three-wheel vehicle. That is, the following description provides examples, and the accompanying drawings show various examples for the purposes of illustration. However, these examples should not be construed in a limiting sense as they are merely intended to provide examples of the three-wheel pressure washer/surface cleaner rather than to provide an exhaustive list of all possible implementations of the three-wheel pressure washer/surface cleaner.

The present invention recognizes and solves one or more of the problems associated with conventional pressure washer/surface cleaners by providing a tubular frame that is specifically designed to be used as a three-wheel pressure washer/surface cleaner. Accordingly, one aspect of embodiments of the present invention provides a three-wheel pressure washer/surface cleaner having two front wheels and one rear wheel. The three-wheel pressure washer/surface cleaner has improved maneuverability and control when compared to conventional three-wheel pressure washer/surface cleaners.

Before delving into the specific details of the three-wheel pressure washer/surface cleaner, it should be noted that the conventions “front,” and “rear,” are defined according to the normal, forward travel direction of the pressure washer/surface cleaner in relationship to the handle of the pressure washer/surface cleaner being discussed.

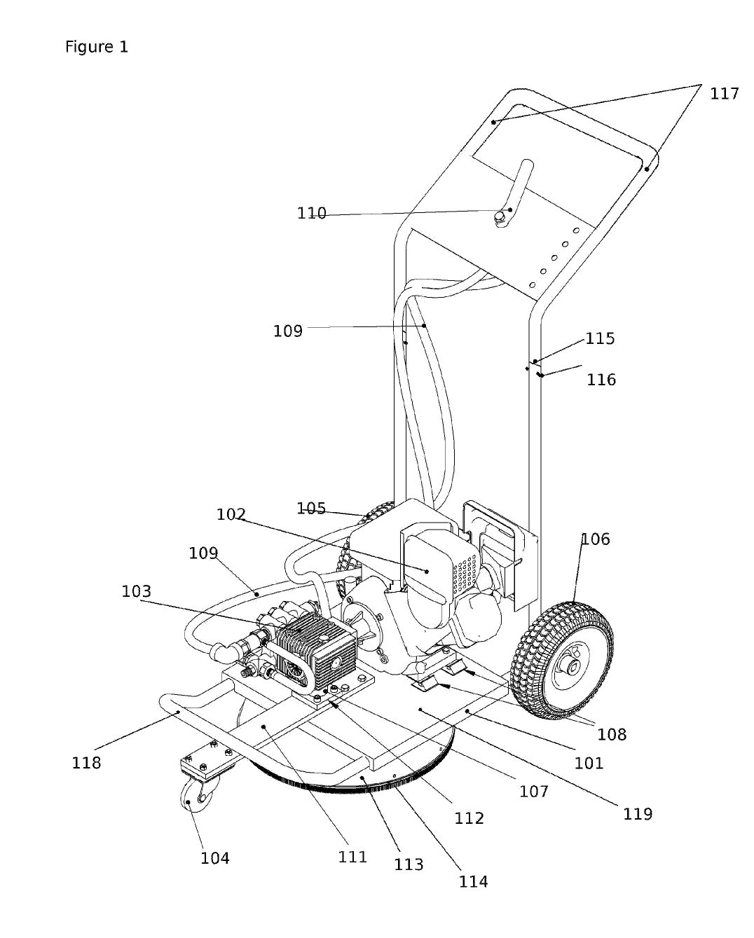

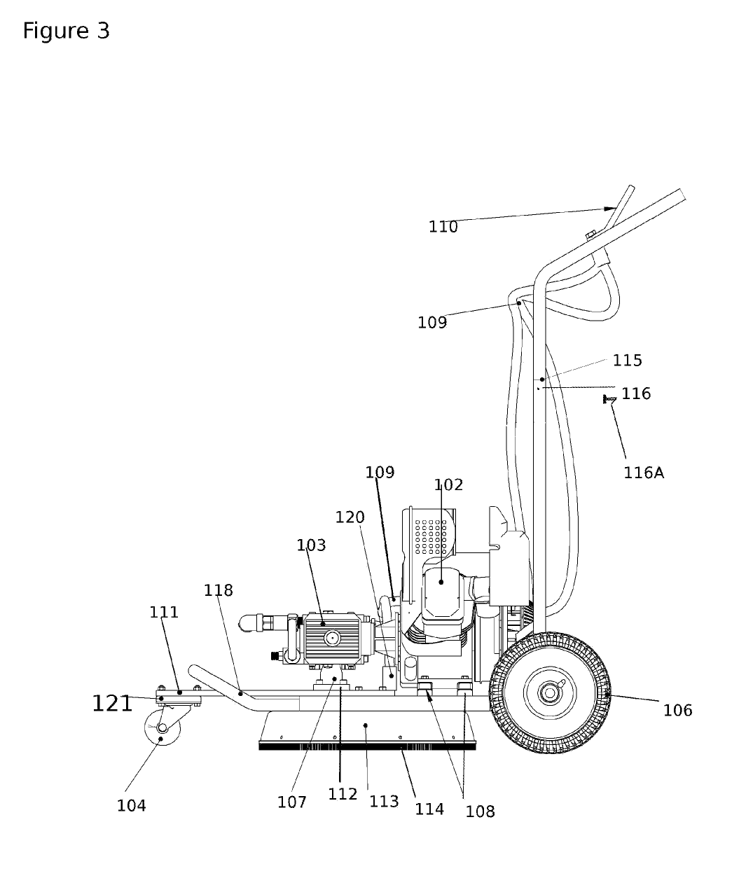

With reference to FIGS. 1, and 3, illustrates a first example of an improved three wheel pressure washer/surface cleaner apparatus according to the present disclosure. FIG. 1 is a isometric view of the improved three wheel pressure washer/surface washer apparatus of the present invention and its mobile steerable platform, FIG. 3 is a side view, of the three wheel pressure washer/surface cleaner and the various elements of the machine. The pressure washer/surface cleaner is mobile and steerable. The present invention allows the user to maneuver the high pressure washer to any desired location in order to perform the high pressure washing/surface cleaning

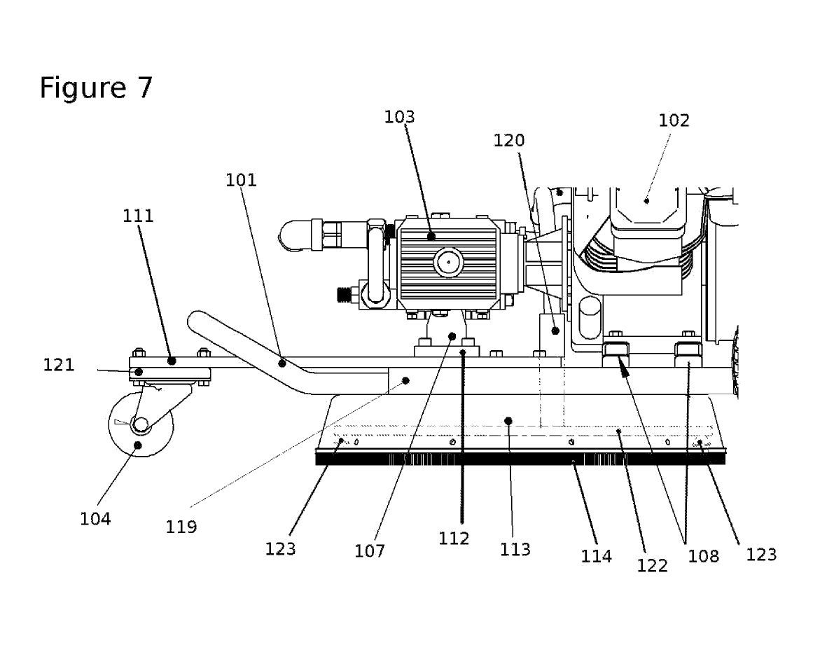

The pressure washer/surface cleaner is shown as including a chassis 101 that consists of a flat metal platform 119 that is attached to a tubular frame 118 that further consists of a handle 117. Upon the flat metal platform 119 is mounted a motor 102 and a high pressure pump 103 attached to the motor. In order to pressure wash horizontal surfaces, to ensure ease of movement and to maneuver the pressure washer/surface cleaner close to vertical objects and structures without destruction of the objects and structures, the chassis 101 is supported by rolling elements, that consists in this case of two pneumatic wheels 105 106 secured to the tubular frame 118 by fixed rigid axles mounted to the rear of the platform 119 and attached to the tubular frame 118. Further a locking swivel wheel 104 is mounted to the front of the pressure washer/surface cleaner in this configuration. The locking swivel wheel 104 is secured to the front of the flat metal platform 119 and attached to the top of the platform 119 with a metal arm 111. The metal arm 111 is of an appropriate width and a length sufficient to allow the swivel wheel 104 to rotate 360 degrees. The metal arm 111 is attached to the top of the chassis 101 and platform 119 starting at the front end of the base of the motor 102 with a hole drilled into the metal arm to permit the attachment of the high pressure hose 109 to a rotating union that is discussed further in FIG. 7.

The chassis 101 and flat metal platform 119 includes a handle 117 that allows for the easy movement of the pressure washer/surface cleaner by the operator. The motor 102 is mounted on the flat metal platform 119 using a plurality of elastometric vibration absorbers 108. The motor 102 may be of gasoline, diesel, natural gas, propane or electric, and of a horse power appropriate to the configuration in question. The number of absorbers is dependent upon the horse power and the weight of the motor that is attached to the flat metal platform 119. The absorbers mount to preexisting holes in the base of the motor 102.

The high pressure pump 103 is supported by an elastometric shock absorber 107 that is mounted to a bracket 112 that is connected to the metal arm 111. A plate is bolted to the bottom of the high pressure pump 103.

A further elastometric shock absorber is attached to the metal arm 111 and in turn connected to the locking swivel wheel 104. The tubular frame 118 is joined to the handle 117 at 115. The handle 117 is the same diameter as the tubular frame 118 but has a fabricated portion that is smaller in diameter than 118 and slides into the tubular frame at 115 and is held in place by locking pins 116A. The locking pins 116A are inserted into holes drilled into the tubular frame 118 and handle 117 as depicted at 116.

The motor 102 may be of gasoline, diesel, natural gas, propane or electric, and of a horse power appropriate to the configuration in question. A preferred motor, that is the type illustrated in the figures, is a gasoline-powered motor of sufficient power to operate the high pressure pump at manufacturer pressure ratings. The invention described herein is not limited to any particular motor or high pressure pump.

Low pressure water is supplied to the pressure washer pump 103 through a low pressure hose that is connected to a standard water supply. The motor 102 and high pressure pump operate 103 in a conventional manner. A high pressure hose 109 is connected to a high pressure three-way valve 110. From the three way valve 110, two high pressure hoses may be attached either to a hose attached to a wand or to the rotary union 120. The high pressure hoses connected to the pressure washer pump 103 described herein are fitted with quick connect couplings, if desired, so that the hoses may be quickly connected and disconnected.

FIGS. 1 and 3 show the round housing 113 attached to the flat metal platform 119. The round housing 113 is commercially available. The housings 113 are available in a variety of material from stainless steel, aluminum, composite material, to plastic. The housing 113 is bolted to the bottom of the reinforced tubular frame 118 and flat metal platform 119. Attached to the housing 113 at its base is a brush 114 that is the same length as the circumference of the round housing 113. A high pressure hose 109 is connected to the rotary union 120 that is attached to the center of the round housing 113. Connected to the rotary union 120 are two or three arms described further in the detail description of FIG. 7. Attached at the end of the arms are spray nozzle fittings described further in the detail description of FIG. 7. The spray nozzles are aimed at the surface to be cleaned and are available with a variety of nozzle angles, orifice sizes and configurations.

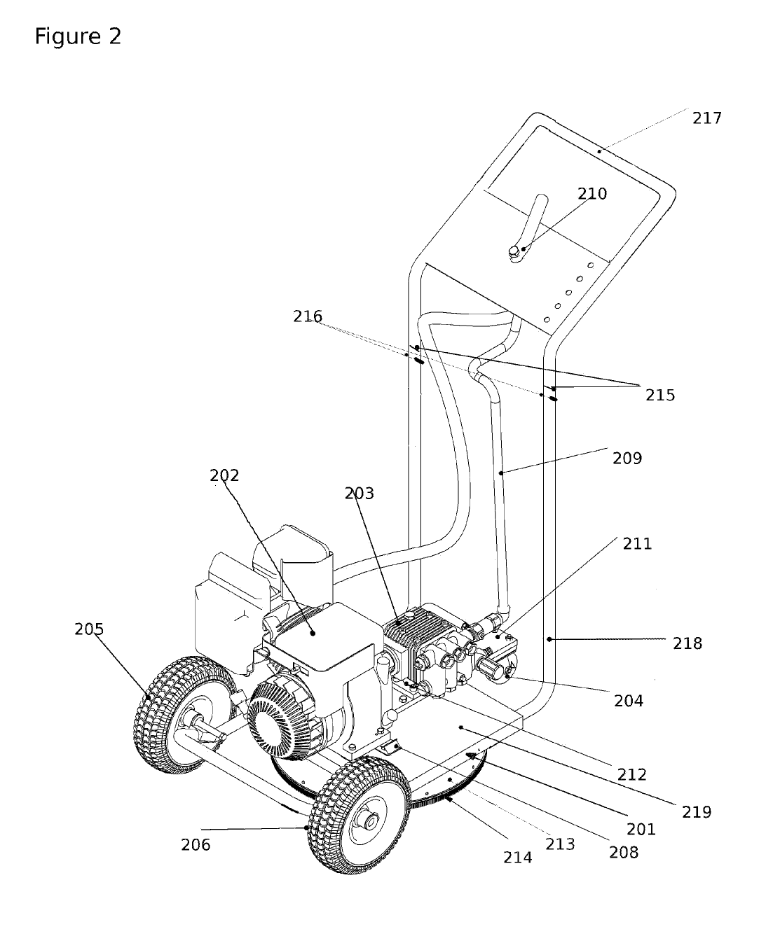

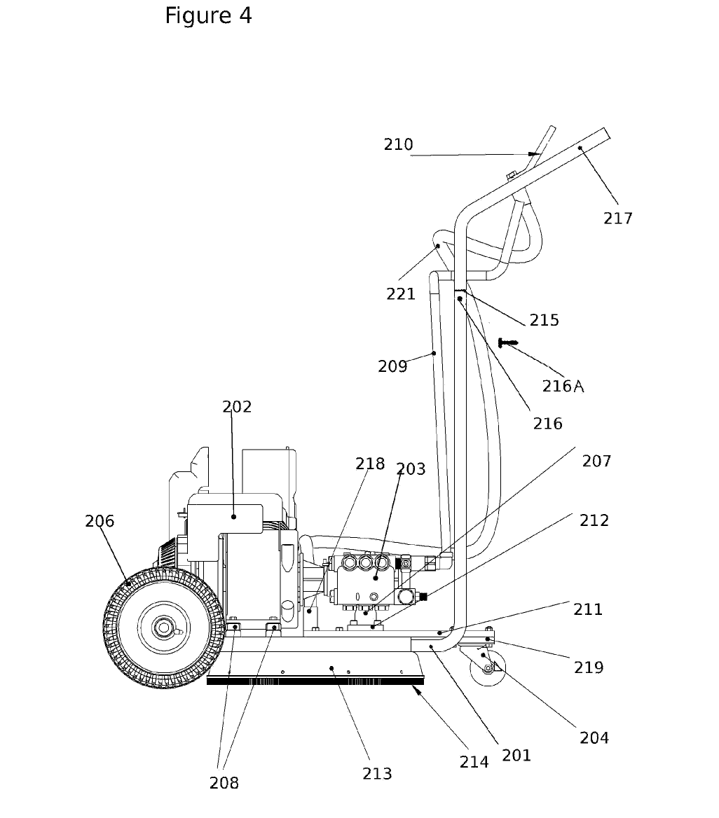

With reference to FIGS. 2, and 4, illustrates a second example of an improved pressure washer/surface cleaner apparatus according to the present disclosure. FIG. 2 is a isometric view of the improved pressure washer/surface washer apparatus of the present invention and its mobile steerable platform, FIG. 4 is a side view, of the platform itself and the various elements mounted thereon. The pressure washer/surface cleaner apparatus and mobile steerable platform of the present invention allows the user to maneuver the high pressure washer to the desired location in order to perform the high pressure washing/surface cleaning desired.

The pressure washer/surface cleaner is shown as including a chassis 201 that consists of a flat metal platform 219 that is attached to a tubular frame 218 that further consists of a handle 217. Upon the flat metal platform 219 is mounted a motor 202 and a high pressure pump 203 attached to the motor.

In order to pressure wash horizontal surfaces, to ensure ease of movement and to maneuver the pressure washer/surface cleaner close to vertical objects and structures without destruction of the objects and structures, the chassis 201 is supported by rolling elements, that consists in this case of two pneumatic wheels 205 206 secured to the tubular frame 218 by fixed rigid axles mounted to the rear of the platform 219 and attached to the tubular frame 218.

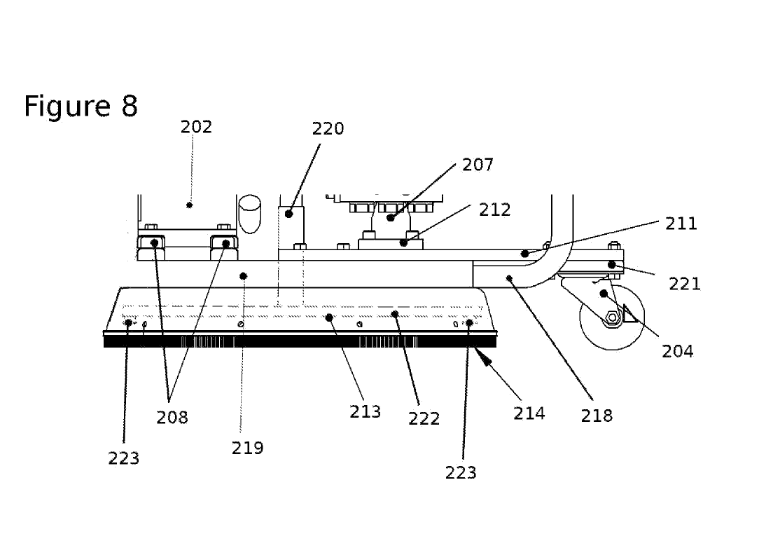

Further a locking swivel wheel 204 is mounted to the front of the pressure washer/surface cleaner in this configuration. The locking swivel wheel 204 is secured to the front of the flat metal platform 219 and attached to the top of the platform 219 with a metal arm 211. The metal arm 211 is of an appropriate width and a length sufficient to allow the swivel wheel 204 to rotate 360 degrees. The metal arm 211 is attached to the top of the chassis 201 and flat metal platform 219 starting at the front end of the base of the motor 202 with a hole drilled into the metal arm to permit the attachment of the high pressure hose 209 to the rotating union, that is discussed further in FIG. 8.

The tubular frame 218 and flat metal platform 219 includes a handle 217 that allows for the easy movement of the pressure washer/surface cleaner by the operator. The motor 202 is mounted on the flat metal platform 219 using a plurality of two, three or four elastometric vibration absorbers 208. The motor 202 may be of gasoline, diesel, natural gas, propane or electric, and of a horse power appropriate to the configuration in question. The number of absorbers is dependent upon the horse power and the weight of the motor that is attached to the flat metal platform 219. The absorbers mount to preexisting holes in the base of the motor 202.

The high pressure pump 203 is supported by an elastometric shock absorber 207 that is mounted to a bracket 212 that is connected to the metal arm 211. A plate is bolted to the bottom of the high pressure pump 203.

A further elastometric shock absorber is attached to the metal arm 211 and in turn connected to the locking swivel wheel 204. The tubular frame 218 is joined to the handle 217 at 215. The handle 217 is the same diameter as the tubular frame 218 but has a fabricated portion that is smaller in diameter than 218 and slides into the tubular frame 218 at 215 and is held in place by locking pins 216A. The locking pins 216A are inserted into holes drilled into the tubular frame 218 and handle 217 as depicted at 216.

The motor 202 may be of gasoline, diesel, natural gas, propane or electric, and of a horse power appropriate to the configuration in question. A preferred motor, that is the type illustrated in the figures, is a gasoline-powered motor of sufficient power to operate the high pressure pump at manufacturer pressure ratings. The invention described herein is not limited to any particular motor or high pressure pump. Low pressure water is supplied to the pressure washer pump 203 through a low pressure hose that is connected to a standard water supply. The motor 202 and high pressure pump operate 203 in a conventional manner.

A high pressure hose 209 is connected to a high pressure three-way valve 210. From the three way valve 210, two high pressure hoses may be attached either to a hose attached to a wand or to the rotary union 220. The high pressure hoses connected to the pressure washer pump 203 described herein are fitted with quick connect couplings, if desired, so that the hoses may be quickly connected and disconnected.

FIGS. 2 and 4 show the round housing 213 attached to the flat metal platform 219. The round housing 213 is commercially available. The housings 213 are available in a variety of material from stainless steel, aluminum, composite material, to plastic. The housing 213 is bolted to the bottom of the reinforced chassis 201 and flat metal platform 219. Attached to the housing 213 at its base is a brush 214 that is the same length as the circumference of the round housing 213. A high pressure hose 209 is connected to the rotary union 220 that is attached to the center of the round housing 213. Connected to the rotary union 220 are two or three arms described further in the detail description of FIG. 8. Attached at the end of the arms are spray nozzle fittings described further in the detail description of FIG. 8. The spray nozzles are aimed at the surface to be cleaned and are available with a variety of nozzle angles, orifice sizes and configurations.

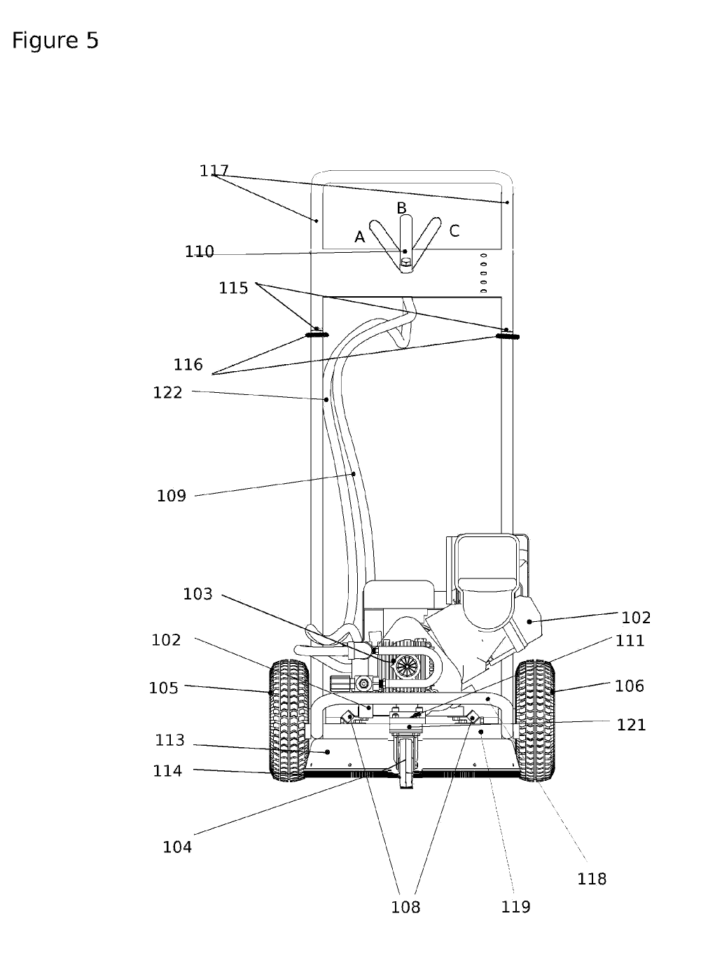

With reference to FIG. 5, the view is a frontal view of the pressure washer/surface cleaner with swivel wheel in the front configuration. A metal arm 111 is attached to the top of the flat metal platform 119. A length of the metal arm 111 extends beyond the flat metal platform 119 is such that a locking swivel wheel 104 will clear the tubular frame 118 and flat metal platform 119 if the swivel wheel 104 is rotated 360 degrees. The metal arm 111 in this instance is mounted to the front. The length of the metal arm 111 is of sufficient length to allow it to be mounted from the front end of the base of the motor 102 to a distance that is sufficient to allow the locking swivel wheel 104 to rotate 360 degrees. The width of the metal arm 111 is of sufficient width to allow the locking swivel wheel 104 mounting bracket to be bolted to the metal arm 111. Between the metal arm 111 and the swivel wheel 104 mounting bracket is placed an elastometric vibration absorber 121 that is slightly larger than the size of the locking swivel wheel 104 bracket.

The high pressure pump 103 supplies water under pressure to the three-way valve 110. High pressure hose 122 supplies high pressure water from the pump to the valve. When the three-way valve 110 is in the position A, the valve is off. When the three-way valve 110 is in position B, the three-way valve 110 supplies high pressure water to high pressure hose 109. High pressure hose 109 supplies water under pressure to the rotating union, described in FIG. 7. When the three-way valve 110 is in position C, a high pressure hose connected to a standard wand may be used in the manner of a stationary pressure washer.

The handle 117 and the connection to the tubular frame 118 at 115 and 116 have been described above. The handle 117 and tubular frame 118 are held together by a locking pin.

The round housing 114 is centered on the flat metal platform 119 from front to rear and in relationship to the wheels 105 and 106 the housing 114 is placed to allow sufficient clearance from the wheels 105, 106. A hole is drilled into the metal arm 111 and the flat metal platform 119 a sufficient distance in front of the motor base 102 to allow the attachment of the rotating union 120 to round housing 114.

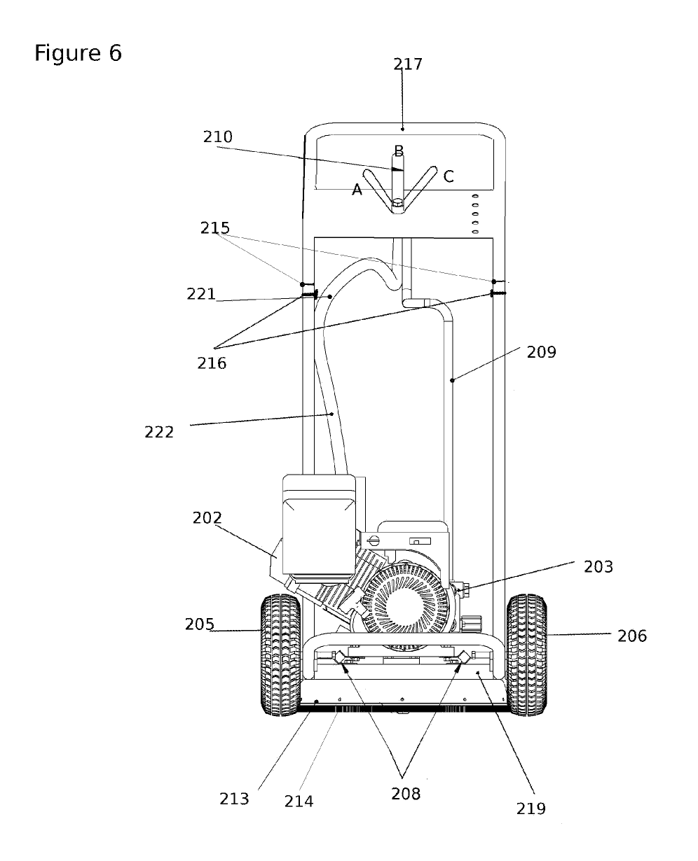

With reference to FIG. 6, the view is a frontal view of the pressure washer/surface cleaner with swivel wheel in the rear configuration. The high pressure pump 203 supplies water under pressure to the three-way valve 210. High pressure hose 222 supplies high pressure water from the pump to the valve. When the three-way valve 210 is in the position A, the valve is off. When the three-way valve 210 is in position B, the three-way valve 210 supplies high pressure water to high pressure hose 209. High pressure hose 209 supplies water under pressure to the rotating union, described in FIG. 8. The round housing 214 is centered on the flat metal platform 219. When the three-way valve 210 is in position C, a high pressure hose connected to a standard wand may be used in the manner of a stationary pressure washer. The handle 217 and the connection to the tubular frame at 215 and 216 have been described in FIG. 2 and FIG. 4 above.

With reference to FIG. 7, the elastometric vibration absorbers 108 is designed to support the motor 102 The absorbers 108 are mounted to the base of the motor 102 in holes provided by the motor manufacturer. Depending upon the size of the motor, a plurality of two, three, or four absorbers may be needed and used.

The elastometric vibration absorber 107 is designed to support the pressure washer pump 103 by means of a bracket 112 mounted to the metal arm 111 that is attached to the flat metal platform 119, separated from high pressure pump 103 by an elastometic material spacer 107 that absorbs the vibration of the high pressure pump 103 and supports the motor 102 and high pressure pump 103. The high pressure pump 103 rests upon vibration absorber 107. A metal plate is bolted to the bottom of the pump 103 that is of sufficient dimensions to be bolted to the pump 103.

The elastometric vibration absorber 119 is designed to support the locking swivel wheel 104 and is mounted to the base of the locking swivel wheel 104, and is further attached to the metal arm 111 and separated from locking swivel wheel base 104 by an elastometic material spacer 119 that absorbs the vibration of the motor 102 and supports metal arm 111.The flat metal platform supports metal arm 111 and is further attached to the metal arm 111.

The rotating union 120 is bolted to the round housing 113. A hole of sufficient diameter is drilled into the metal arm 111 and the base of the flat metal platform 119 to allow the mounting of the rotating union 118. Attached to the rotating union 118 are arms 122 that rotate within the round housing 113. At the end of the arms 122 are attached nozzles 123 that are aimed downward and at an angle to allow the arm 122 to rotate. Depending upon the size of the motor 102 used, the pressure washer/surface cleaner may have a plurality of arms 122.

The round housing 113 has a brush 114 attached to it. The brush 114 has a length that is equal to the circumference of the round housing 113. The brush 114 has a metal band that allows the attachment of the brush 114 to the round housing 113. The brush 114 prevents over spray and allows use of the pressure washer/surface cleaner up close to objects such as vertical surface, horizontal surfaces, plants, shrubs or fixtures without damage. The brush 114 is mounted at a sufficient height to allow free movement along a flat surface of the brush 114.

With reference to FIG. 8, A metal arm 211 is attached to the top of the flat metal platform 219. A length of the metal arm 211 extends beyond the flat metal platform 219 is such that a locking swivel wheel 204 will clear the tubular frame 218 and flat metal platform 219 if the locking swivel wheel 204 in rotated 360 degrees. The metal arm 211 in this instance is mounted to the rear. The length of the metal arm 211 is of sufficient length to allow it to be mounted from the rear end of the base of the motor 202 to a distance that is sufficient to allow the locking swivel wheel 204 to rotate 360 degrees. The width of the metal arm 211 is of sufficient width to allow the locking swivel wheel 204 mounting bracket to be attached to the metal arm 211. Between the metal arm 211 and the swivel wheel 204 mounting bracket is placed an elastometric vibration absorber 221 that is slightly larger than the size of the locking swivel wheel 204 bracket.

The elastometric vibration absorbers 208 is designed to support the motor 202 The absorbers 208 are mounted to the base of the motor in holes provided by the motor manufacturer. Depending upon the size of the motor, a plurality of two, three or four of absorbers may be needed and used.

The elastometric vibration absorber 207 is designed to support the pressure washer pump 203 by means of a bracket 212 mounted to the metal arm 211 that is attached to the flat metal platform 219, separated from high pressure pump 203 by an elastometic material spacer 207 that absorbs the vibration of the of the motor 202. The flat metal platform 219 supports metal arm 211. The high pressure pump 203 rests upon vibration absorber 207. A metal plate is bolted to the bottom of the pump 203 that is of sufficient dimensions to be bolted to the pump 203.

The elastometric vibration absorber 221 is designed to support the locking swivel wheel 204 and is mounted to the base of the locking swivel wheel 204, and is further attached to the metal arm 211 and separated from locking swivel wheel base 204 by an elastometic material spacer 219 that absorbs the vibration of the motor 202 and supports metal arm 211.

The round housing 214 is centered on the flat metal platform 219 from front to rear and in relationship to the wheels 205 and 206 the housing 214 is placed to allow sufficient clearance from the wheels 205, 206. A hole is drill into the metal arm 211 and the flat metal platform 219 a sufficient distance from the rear of the motor base 202 to allow the attachment of the rotating union 220 to round housing 214. The rotating union 220 is bolted to the round housing 213. A hole of sufficient diameter is drilled into the metal arm 211 and the base of the tubular frame 218 to allow the mounting of the rotating union 218.

Attached to the rotating union 220 are arms 222 that rotate within the round housing 213. At the end of the arms 222 are attached nozzles 223 that are aimed downward and at an angle to allow the arm 222 to rotate. Depending upon the size of the motor used, the pressure washer/surface cleaner may have 2, 3 or 4 arms 222. The round housing 213 has a brush 214 attached to it. The brush 214 has a length that is equal to the circumference of the round housing 213. The brush 214 has a metal band that allows the attachment of the brush 214 to the round housing 213.The brush 214 prevents over spray and allows use of the pressure washer/surface cleaner up close to objects such as vertical surface, horizontal surfaces, plants, shrubs or fixtures without damage. The brush 214 is mounted at a sufficient height to allow free movement along a flat surface of the brush 214.

We claim:

1. An improved pressure washer/surface cleaner comprising a chassis with a tubular frame, platform and handle assembly whereby the handle is attached to the tubular frame by means of locking pins and is removable from the tubular frame;

2. An improved pressure washer/surface cleaner comprising a means of reducing vibration of a motor where;
a. the motor is attached to and supported by a platform to which is attached a plurality of elastometic vibration absorbers, where the number of vibration absorbers is dependent upon the type and horse power of the motor;
b. the base of a high pressure pump is supported by and resting upon an elastometric vibration absorber attached and secured to a platform;
c. an elastometric vibration absorber secured and attached to the base plate of a locking swivel wheel and attached and secured to end of a metal arm that supports the locking swivel wheel device where a metal arm is attached to and supported by a platform that also has a motor and high pressure pump attached thereto;

3. An improved pressure washer/surface cleaner comprising three wheels attached to and supported by a tubular frame and platform wherein two of the wheels are pneumatic wheels attached at to one end of a chassis and a third wheel, that is a swiveling wheel, attached to the other end of the chassis by means of a metal arm a locking swivel wheel;

4. An improved pressure washer/surface cleaner comprising a means whereby a swivel wheel with a locking mechanism, that prevents the swivel wheel from rotating and moving along a horizontal surface when engaged, that is located and assembled depending upon configuration in relationship to the handle to the front of the pressure washer/surface cleaner or to the rear of the pressure washer/surface cleaner;

5. An improved pressure washer/surface cleaner comprising a device that is a round metal or non-ferrous material housing with a brush, that is the length of the circumference of the round metal or non-ferrous material housing, attached and secured to the bottom circumference of the housing, that is movable along a surface, positioned at such a height that allows the brush to clear a horizontal surface with a minimum of clearance.
